(19) United States
(12) Patent Application Publication
(10) Pub. No.: US 2016/0353231 A1
(43) Pub. Date: Dec. 1, 2016

(54) AN EMBEDDED OPERATING SYSTEM FOR ACHIEVING BLUETOOTH SLAVE DEVICE FUNCTION AND THE METHOD THEREOF

(71) Applicant: YUTOU TECHNOLOGY (HANGZHOU) CO., LTD., Hangzhou City (CN)

(72) Inventor: Jiaqi SHI, Hangzhou City (CN)

(21) Appl. No.: 14/763,748

(22) PCT Filed: Jun. 12, 2015
(86) PCT No.: PCT/CN2015/081393

§ 371 Date: Jul. 27, 2015

(30) Foreign Application Priority Data
Jan. 12, 2015 (CN) 201510014816.4

(51) Int. Cl. H04W 4/00; H04W 76/02

(52) U.S. Cl. CPC H04W 4/008; H04W 76/023

(57) ABSTRACT

An embedded operating system for achieving Bluetooth slave device function and the method thereof, the system having: a mobile terminal, which provided with an embedded operating system; a Bluetooth module, configured to at least work in a Bluetooth slave device mode; an interface module, connecting the Bluetooth module and the mobile teiininal; wherein, the mobile terminal drives the Bluetooth module to operate through the interface module. Using the device described above, achieves the supporting function of adding Bluetooth slave devices to the operating system without modifying the source code of existing embedded operating system, thus the extension of the Bluetooth protocol stack will not be affected by the interface and the service of the operating system any more, improving extensibility and flexibility of the entire system.

### BACKGROUND OF THE INVENTION

1. Field of the Invention

The invention relates to a field of communication technology, especially to an embedded operating system for achieving Bluetooth slave device function and the method thereof

2. Description of the Related Art

With the development of the wireless communication technology and the expansion of market size, Bluetooth technology is being applied more broadly and involving more and more people. From cell phones to the smart home, from the sensor network to home service robots, Bluetooth technology has been widely utilized in a wide variety of applications and devices.

Bluetooth technology is a short distance wireless transmission technology, which can solve communication problems among identical devices or different devices such as cell phones, computers, sensors and even robots. Bluetooth Protocol and Profile are important parts of Bluetooth technology, wherein Bluetooth Protocol defines the communication mode between it and other systems (protocols), and describes the signal timing and the communication data agency; wherein Bluetooth Profile, directing at some applications and particular scenarios, defines protocols being adopted by these scenarios and the task sequence of various protocols, so as to ensure the interactive operability among devices. Most of the Bluetooth Profiles classify the device as the master device and the slave device. For example, Bluetooth Advanced Audio Distribution Profile (A2DP) implementing audio distribution profile model classifies the device as the master device (SRC) and the slave device (SNK), wherein the audio stream sender is SRC, and the receiver is SNK. At present, all the cell phones and tablet PCs have achieved the master device (SRC) in A2DP, these devices based on IOS or Android intelligent operating system, utilize Bluetooth Protocol Stack of the operating system itself to implement the master device (SRC) defined in the profile. With respect to the device, based on Android intelligent operating system, Protocol Stack could be Bluz or Bluedroid. These Protocol Stack software have achieved many profiles of Bluetooth, and their architectures are shown in FIG. 1.

However, as shown in FIG. 1, because the operating system manufacturer underestimates application scenarios of intelligent devices, the majority of profiles (such as HFP, A2DP, AVRCP) in Bluetooth Protocol Stack of the embedded operating system, such as Linux, Android and so on, do not include the slave device function. At present, the domestic and overseas intelligent devices based on an embedded operating system, such as cell phones, tablet PCs, smart TVs, the smart home and so on, could only achieve the master device function of these profiles. Bluetooth devices configured in the intelligent devices only include some basic Bluetooth protocols, and the upper layer protocol and profile is implemented in the operating system. With the development of robot technology, some robots, based on an embedded operating system like embedded Linux, Android and others, need the slave device function of the profile, such as A2DP, HFP, AVRCP and so on, therefore, the industry needs to implement the technical measures of the embedded operating system achieving Bluetooth slave device.

### SUMMARY OF THE INVENTION

Directing at the problem that the existing embedded operating system is unachievable with Bluetooth slave device function, the invention provides an embedded operating system achieving Bluetooth slave device and the method thereof

The technical solution of the invention is:

An embedded operating system for achieving Bluetooth slave device function, comprising:

A mobile terminal, provided with an embedded operating system;

A Bluetooth module, configured to at least work in Bluetooth slave device mode;

An interface module, connecting the Bluetooth module and the mobile terminal; the mobile terminal drives the Bluetooth module to operate through the interface module.

Preferably, the Bluetooth module comprises:

A control unit;

A Bluetooth receiving and transmitting unit, connected to the control unit;

An external interface unit, respectively connected to the control unit and the interface module;

A Bluetooth antenna, connected to the Bluetooth receiving and transmitting unit;

The control unit is connected to the mobile terminal through the external interface unit, and is configured, according to the instructions from the mobile terminal, to control the Bluetooth receiving and transmitting unit to communicate with the mobile terminal through the external interface unit.

Preferably, the control unit comprises:

A first storage unit, configured to store the complete protocol stack of the Bluetooth slave device function, said complete protocol stack of Bluetooth slave device function being configured to control the operation of the Bluetooth receiving and transmitting unit;

A second storage unit, configured to store the interface protocol stack, said interface protocol stack being configured for communication between the Bluetooth module and the mobile terminal

Preferably, the external interface unit and the interface module are serial interfaces.

Preferably, the serial interfaces could be serial asynchronous interfaces, serial peripheral interfaces, internal integration bus or the serial fast input and output interface.

Preferably, the embedded operating system is Android or Linux.

Preferably, further comprising:

A method for using an embedded operating system to achieve Bluetooth slave device function, comprising:

Step 1: providing a Bluetooth module, the Bluetooth module, at minimum, being configured to work in Bluetooth slave device mode and to have the complete protocol stack of Bluetooth slave device function;

Step 2: connecting the Bluetooth module to a mobile terminal through an interface module;

Step 3: the mobile terminal drives the Bluetooth module to operate its own the protocol stack of Bluetooth slave device function;

Step 4: the Bluetooth module conducts data communication with the mobile terminal through the interface module.

Preferably, the interface module is a serial interface.

Preferably, the mobile terminal employs an operating system, which is Android or Linux.

The benefit of the invention compared to the prior art is: Using present system and method thereof, makes the technical solution different from the current solution in which the Bluetooth protocol stack software is integrated within the operating system. The invention utilizes extra hardware to implement and handle the Bluetooth protocol stack, then associates Bluetooth profile, which is the complete external Bluetooth protocol stack, including master-slave devices, with the embedded operating system through the software and hardware interface profile, thus achieving the supporting function of adding Bluetooth slave devices to the operating system without modifying the source code of existing embedded operating system; meanwhile, the invention does not couple with the operating system, having portability, with which it can be easily transplanted into various embedded operating systems after the completion of a Bluetooth protocol stack, even into a closed-source operating system, thus without affecting by the interface and the service of the operating system any more, improving extensibility and flexibility of the entire system.

### BRIEF DESCRIPTIONS OF THE DRAWINGS

FIG. 1 is an architecture diagram of the protocol stack of the Bluetooth software in the art;

FIG. 2 is a system principle diagram of the present invention;

FIG. 3 is a model diagram of the 4 layers of software and hardware interface specification of the interface module according to the invention;

FIG. 4 is a driver architecture diagram of an embodiment based on Android intelligent operating system;

FIG. 5 is a flow chart of the method of the invention.

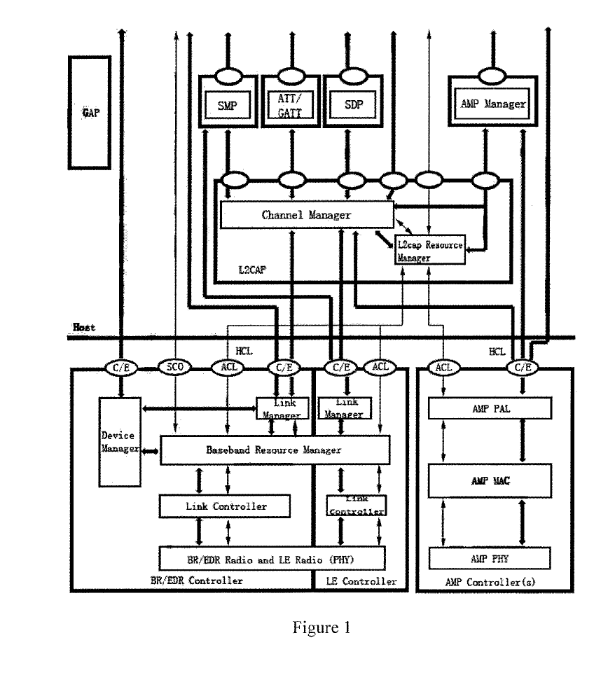

### DETAILED DESCRIPTIONS

The following is a further description of the invention, which combines the drawing and the embodiments, and it is not to be the limitation for the invention.

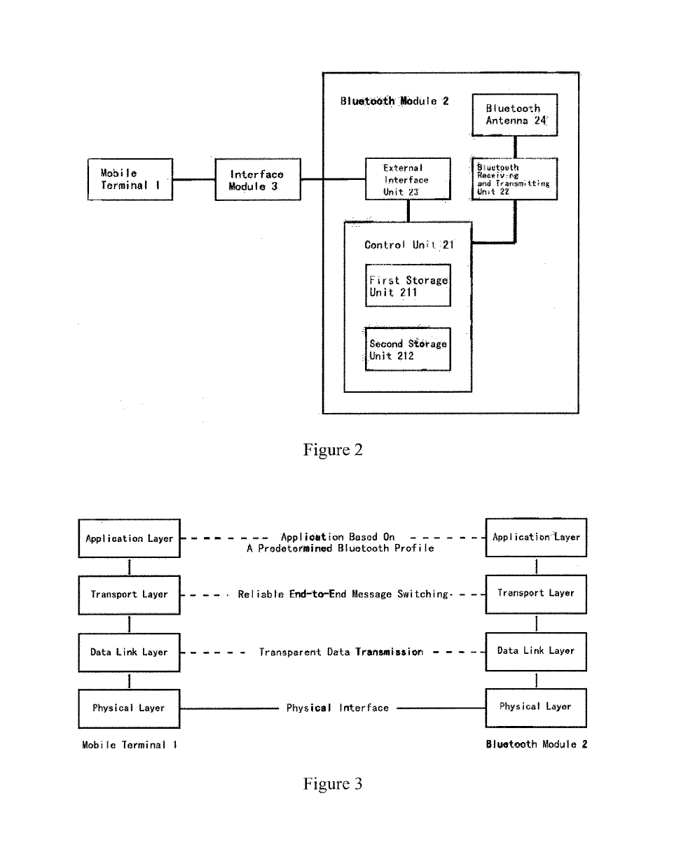

As shown in FIG. 2, the technical solution of the present invention discloses the embedded operating system, achieving Bluetooth slave device function, wherein it comprises: a mobile terminal 1, provided with an embedded operating system; a Bluetooth module 2, which configured to at least work in Bluetooth slave device mode; an interface module 3, connecting the Bluetooth module 2 and the mobile terminal 1; the mobile terminal 1 drives the Bluetooth module 2 to operate through the interface module 3.

In the above technical solution, with an external Bluetooth module 2, which, at minimum, works in Bluetooth slave device mode, it can make the mobile terminal 1 communicate with the external Bluetooth master device in slave device mode, the Bluetooth module 2 communicates with the mobile terminal 1 through the interface module 3, driving the Bluetooth module 2 working by the mobile terminal 1

Preferably, the Bluetooth module 2 comprises: a control unit 21; a Bluetooth receiving and transmitting unit 22, connected to the control unit 21; an external interface unit 23, respectively connected to the control unit 21 and the interface module 3; a Bluetooth antenna 24, connected to the Bluetooth receiving and transmitting unit 22.

The control unit 21 is connected to the mobile terminal through the external interface unit, and is configured, according to the instructions from the mobile terminal, to control the Bluetooth receiving and transmitting unit 22 to communicate with the mobile terminal 1 through the external interface unit 23. At the same time, under the control of the control unit 21, the Bluetooth receiving and transmitting unit 22 communicates with external Bluetooth master device in the form of Bluetooth slave device, and the Bluetooth antenna 24 is used to transmit and receive radio signals.

Preferably, the control unit 21 comprises:

A first storage unit 211, applied to storing the complete protocol stack of Bluetooth slave device function, said complete protocol stack of Bluetooth slave device function is used to control the work of the Bluetooth receiving and transmitting unit 22;

A second storage unit 212, responsible for storing the interface protocol stack; said interface protocol stack is used to allow communication between the Bluetooth module 2 and the mobile terminal 1.

In a preferable embodiment, the control unit 21 could be formed by a single chip micyoco with low power consumption. The protocol stack of Bluetooth slave device function could be developed in the single chip micyoco, written in C language, which would form the first storage unit 211 with the storage space of the single chip micyoco. Additionally, the second storage unit 212 could also be formed in the storage space of the single chip micyoco, which can store drivers and the interface protocol stack of the external interface unit 23.

Through the Bluetooth receiving and transmitting unit 22, the Bluetooth module 2 receives the Bluetooth data packets from the Bluetooth antenna 24, after treatment of the protocol stack in the control unit 21, transmits the data to the mobile terminal 1, or receives the data from the mobile terminal 1 then encapsulating as Bluetooth data packets, transmitting to the Bluetooth receiving and transmitting unit 22 through the Bluetooth antenna 24.

Preferably, the external interface unit 23 and the interface module 3 are serial interfaces. As a preferable embodiment, the external interface unit 23 could employ a Universal Asynchronous Receiver and Transmitter (UART), or a Serial Peripheral Interface (SPI), or an Inter-Integrated Circuit (I2C), or a Serial Rapid Input Output (SRIO).

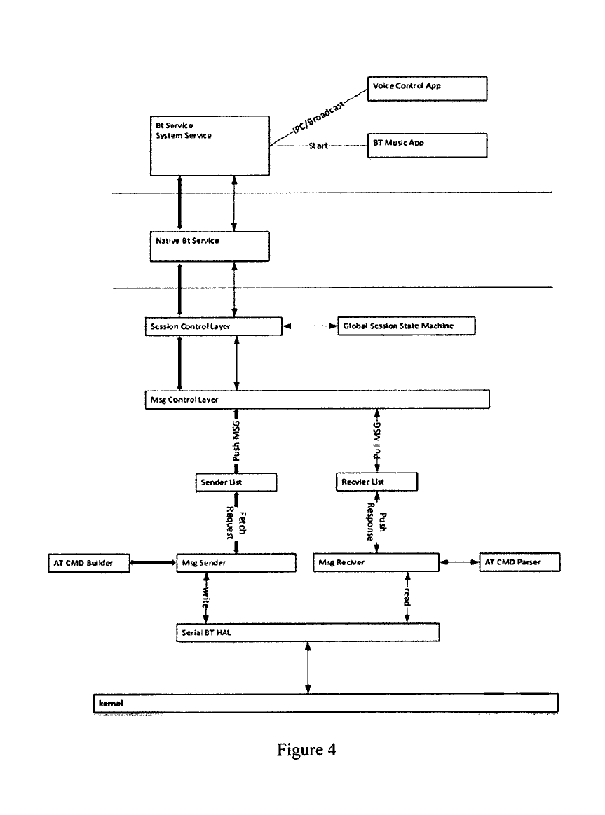

In the above technical solution, the software and hardware interface profile of the interface module 3 is a bridge, which connects the Bluetooth module 2 with the mobile terminal 1. The profile could be a specific hardware communication interface in the hardware and be a layer of communication protocol stack within the software The protocol stack defines the data packet format and transfer timing between the Bluetooth module 2 and the mobile terminal 1. As shown in FIG. 3, the protocol stack consists of 4 layers, which are the application layer, the transport layer, the data link layer and the physical layer, respectively. The application layer serves the application program directly, specifically orienting some definite Bluetooth profile application to formulate the data packet format and transfer timing. The transport layer takes charge of transmission and the control of data, thus providing a dependable data exchanging function in end-to-end service. The function of the data link layer is to provide the upper layer with transparent data transmission in basic services. The physical layer defines supplied mechanical, electrical, functional, and nonnative features, based on creation, maintenance, and removal of the physical link, required in data transmission. In a more preferable embodiment, the interface module 3 can be configured inside the mobile terminal 1, consisting of the software and hardware of the mobile terminal 1.

In the above technical solution, the mobile terminal 1 further comprises a driver of an embedded operating system, the driver runs inside the operating system of the mobile terminal 1, which specifically takes charge of receiving the requirements of the application program, encapsulating the requirements into the data packet, then transmitting them to the Bluetooth module 2 through the interface module 3, or receiving the notice from the Bluetooth module 2 and sending the notice to upper layer application running in the mobile terminal 1.

In a preferable embodiment, in an intelligent robot based on Android embedded operating system, the intelligent robot needs to have the functions of Bluetooth phone and Bluetooth music. First, a user uses the cell phone to make Bluetooth pairing with the robot, the user then can interact with the robot, commanding the robot to make calls or play music in the cell phone via Bluetooth. In this case, the robot needs to have the slave device function of Bluetooth profile such as A2DP, HFP, AVRCP.

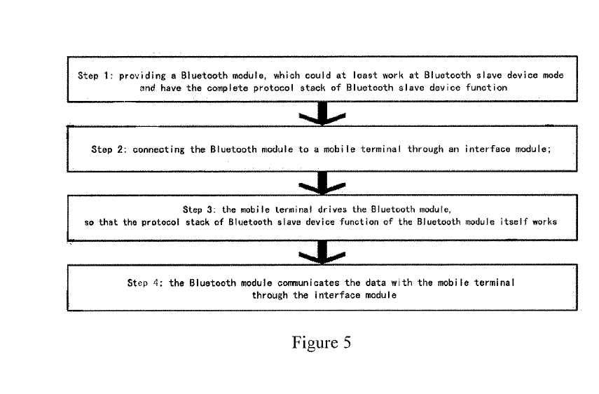

At present, traditional Android embedded operating system does not support the slave device function. After employing the system, according to the present invention, the intelligent robot is an embodiment of mobile terminal 1 in the above technical solution, in this case, it does not have Android native Bluetooth protocol stack, and could use the protocol stack in the Bluetooth module 2, wherein the protocol stack in the Bluetooth module 2 includes complete A2DP, HFP, AVRCP Bluetooth slave device function. Now, using the serial interface (namely the embodiment of interface module 3) as the communication interface connecting the mobile terminal 1 with the Bluetooth module 2, achieving the driver and service based on Android as shown in FIG. 4. So the robot can achieve the function of making calls or playing music by Bluetooth.

Take the phone call, as an example, for demonstrating its workflow: at first, a user commands a robot to make calls, and the robot invokes application after receiving the command, the application encapsulates contents of the command into data packets according to the model in FIG. 3, then transmits data packets to the Bluetooth module 2; the Bluetooth module 2 unpacks data packets, then executes the phone call process prescribed in HFP through the Bluetooth protocol stack, thus achieving the function of calling Bluetooth phone.

In a more preferable embodiment, the embedded operating system is Android or Linux.

The technical solution in the present invention further comprises:
A method of an embedded operating system achieving Bluetooth slave device function, as shown in FIG. 5, comprises the following steps:

Step 1: providing a Bluetooth module, the Bluetooth module, at minimum, being configured to work in Bluetooth slave device mode and to have complete protocol stack of the Bluetooth slave device function;

Step 2: connecting the Bluetooth module to a mobile terminal through an interface module;

Step 3: the mobile terminal drives the Bluetooth module to operate its own the protocol stack of Bluetooth slave device function;

Step 4: the Bluetooth module conducts data communication with the mobile terminal through the interface module.

Preferably, the interface module is a serial interface.

Preferably, the mobile terminal employs an operating system, which is Android or Linux.

In conclusion, using the device described above, which makes the present invention different from the current solution, which has the Bluetooth protocol stack software integrated within the inside of the operating system. The invention utilizes extra hardware to implement and handle the Bluetooth protocol stack, then associates the Bluetooth profile, intelligent devices required, which is the complete external Bluetooth protocol stack, including master-slave devices, with the embedded operating system in mobile terminal through the software and hardware interface, thus achieving the supporting function of adding Bluetooth slave devices to the operating system without modifying the source code of the existing embedded operating system; meanwhile, the invention does not couple with the operating system, having portability, with which it can be easily transplanted into various embedded operating systems after the completion of a Bluetooth protocol stack, even into a closed-source operating system, thus without a Bluetooth protocol stack affected by the interface and the service of the operating system any more, improving extensibility and flexibility of the entire system.

The above description is only the preferred embodiments of the invention, and it does not limit the implement method and protecting scope of the invention. It is obvious for the skilled in the art that the changes and variations made by the specification and drawings of the invention should fall into the scope of the invention.

What is claimed is:

1. An embedded operating system for achieving Bluetooth slave device function, wherein comprising:
a mobile terminal, provided with an embedded intelligent operating system;
a Bluetooth module, configured to at least work in a Bluetooth slave device mode;
an interface module, connecting the Bluetooth module and the mobile terminal;
Wherein, the mobile terminal drives the Bluetooth module to operate through the interface module.

2. The system as claimed in claim 1, wherein the Bluetooth module comprises:
a control unit;
a Bluetooth receiving and transmitting unit, connected to the control unit;
an external interface unit, respectively connected to the control unit and the interface module;
a Bluetooth antenna, connected to the Bluetooth receiving and transmitting unit;
Wherein, the control unit is connected to the mobile terminal through the external interface unit, and is configured, according to the instructions from the mobile terminal, to control the Bluetooth receiving and transmitting unit to communicate with the mobile terminal through the external interface unit.

3. The system as claimed in claim 2, wherein the control unit comprises:
a first storage unit, configured to store the complete protocol stack of the Bluetooth slave device function, said complete protocol stack of Bluetooth slave device function being configured to control the operation of the Bluetooth receiving and transmitting unit;
a second storage unit, configured to store the interface protocol stack, said interface protocol stack being configured for communication between the Bluetooth module and the mobile terminal

4. The system as claimed in claim 2, wherein the external interface unit and the interface module are serial interfaces.

5. The system as claimed in claim 4, wherein the serial interfaces could be serial asynchronous interfaces, serial peripheral interfaces, internal integration bus or the serial fast input and output interface.

6. The system as claimed in claim 1, wherein the embedded operating system is Android or Linux.

7. The system as claimed in claim 2, wherein the embedded operating system is Android or Linux.

8. The system as claimed in claim 3, wherein the embedded operating system is Android or Linux.

9. The system as claimed in claim 4, wherein the embedded operating system is Android or Linux.

10. The system as claimed in claim 5, wherein the embedded operating system is Android or Linux.

11. A method for using an embedded operating system to achieve Bluetooth slave device function, comprising:
Step 1: providing a Bluetooth module, the Bluetooth module, at minimum, being configured to work in Bluetooth slave device mode and to have complete protocol stack of the Bluetooth slave device function;
Step 2: connecting the Bluetooth module to a mobile terminal through an interface module;
Step 3: the mobile terminal drives the Bluetooth module to operate its own the protocol stack of Bluetooth slave device function;
Step 4: the Bluetooth module conducts data communication with the mobile terminal through the interface module.

12. The method as claimed in claim 11, wherein the interface module is a serial interface.

13. The method as claimed in claim 12, wherein the mobile terminal employs an operating system which is Android or Linux.
